(19) United States
(12) Patent Application Publication
(10) Pub. No.: US 2013/0183397 A1
(43) Pub. Date: Jul. 18, 2013

(54) ENGRAVING APPARATUS

(71) Applicant: BENQ MATERIALS CORPORATION, Taoyuan County (TW)

(72) Inventors: Lung-Hai WU, Taoyuan County (TW); Fung-Hsu WU, Taoyuan County (TW)

(73) Assignee: BENQ MATERIALS CORPORATION, Taoyuan County (TW)

(21) Appl. No.: 13/744,431

(22) Filed: Jan. 18, 2013

(30) Foreign Application Priority Data
Jan. 18, 2012 (TW) 101201294

(51) Int. Cl. B29C 59/02

(52) U.S. Cl. CPC B29C 59/026
USPC 425/385

(57) ABSTRACT

An engraving apparatus of rubbing rollers for manufacturing retarder films is provided. The engraving apparatus comprises a body and an engraving end including a plurality of micro-groove structures. The plurality of micro-groove structures of the engraving end are arranged in parallel or irregularly. The engraving apparatus rubs on the rollers using the engraving end in a predetermined direction. Then the predetermined pattern structures are rubbed on the roller. In the rubbing process, the engraving apparatus can rub different pattern structures backwards and forwards directly without to move the engraving apparatus to the starting position of engraving paths. It keeps the manufacturing speed to manufacture the retarder film for saving the process time and the manufactured retarder film with the accuracy.

### RELATED APPLICATION

This application claims priority to Taiwan Application Ser. No. 101201294, filed Jan. 18, 2012, which is herein incorporated by reference.

### BACKGROUND

1. Technical Field

The prevent invention relates to an engraving apparatus of making rollers, and more particularly to an engraving apparatus of making rollers for manufacturing retarder films.

2. Description of the Related Art

A retarder film has been developed and applied to a liquid crystal display (LCD) to generate a visual three-dimensional stereo effect. The retarder film is commercialized in products, like stereoscopic display glasses, stereoscopic display TVs and other display products.

For the display products, keeping the accuracy in manufacturing process of the retarder film is required to ensure an optical quality of the retarder film. However, the accuracy requirement of manufacturing process therefore reduces manufacturing speed of the retarder film.

It is known that the retarder film is manufactured by using rollers having specific micro-groove structures to emboss a curable resin, such that the specific micro-groove structures are transferred to the curable resin. Afterwards liquid crystal is coated on the curable resin so as to form the retarder film. The specific micro-groove structures of the retarder film in associate with the liquid crystal render a specific phase difference value to the retarder film.

Some methods for manufacturing the retarder film having the specific micro-groove structures are provided in the art. For example, an engraving apparatus is used to engrave the rollers. After engraving the rollers by the engraving apparatus, some specific micro-groove structures are transferred to the surface of rollers. Then, the rollers can be used to emboss the retarder film to make the retarder film having the specific micro-groove structures. However, it is needed longer processing time to change engraving directions and engraving angles of the engraving apparatus in the engraving step. Sometimes, the engraving apparatus fails to accurately engrave the transferred area on the surface of the rollers in the engraving step.

The present invention intends to provide a novel apparatus for manufacturing the retarder film to solve the mentioned issues.

### SUMMARY

The invention is to provide an engraving apparatus of making rollers for manufacturing retarder films.

According to an aspect of the present invention, an engraving apparatus is provided for making a roller including a roller surface, in use of manufacturing a retarder film. The engraving apparatus includes a body and an engraving end having a plurality of micro-groove structures.

In an engraving process, the engraving end moves over the roller surface of the roller and rubs the roller surface in a predetermined direction. Accordingly, predetermined pattern structures are rubbed on the roller surface in the predetermined direction and individually with a predetermined spacing, depth and width.

In some embodiments, the micro-groove structures of the engraving end are arranged in parallel or irregularly.

In the rubbing process, the engraving apparatus according to the embodiments of the present invention are able to rub the roller surface by changing rubbing direction of the engraving end. Also, the pattern structures are formed by the rubbing the roller surface, instead of transferred from the micro-groove structures of the embossing tool. As such, the engraving apparatus can manufacture a retarder film with a required accuracy and manufacturing speed.

The above and other embodiments of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of one embodiment of an engraving apparatus of a roller for manufacturing a retarder film according to the present invention;

FIG. 2 is a partial enlarged view of the schematic diagram of he engraving apparatus of FIG. 1; and

FIG. 3 is a schematic diagram of another embodiment of an engraving apparatus according to the present invention.

### DETAILED DESCRIPTION OF THE INVENTION

This specification discloses one or more embodiments that incorporate the features of present invention. The disclosed embodiment(s) merely exemplify the invention. The scope of the invention is not limited to the disclosed embodiment(s). The invention is defined by the claims appended hereto.

The embodiments(s) described, and references in the specification to “one embodiment,” “an example embodiment,” etc., indicate that the embodiment(s) described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

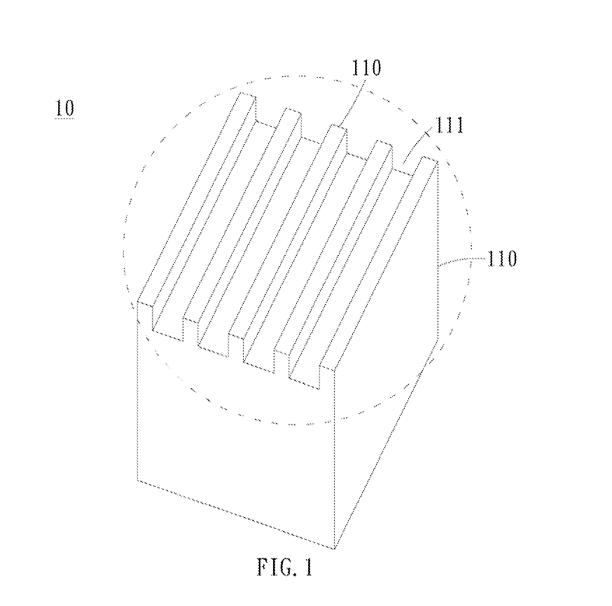

FIG. 1 shows a schematic diagram of one embodiment of an engraving apparatus 10 of a roller manufacturing a retarder film (not shown) according to an embodiment of the present invention. The engraving apparatus 10 includes a body 100 and an engraving end 110. In one embodiment, the body 100 is a hexahedral and the engraving end 110 is disposed at one side of the body 100. In addition, the engraving end 110 includes a plurality of micro-groove structures 111.

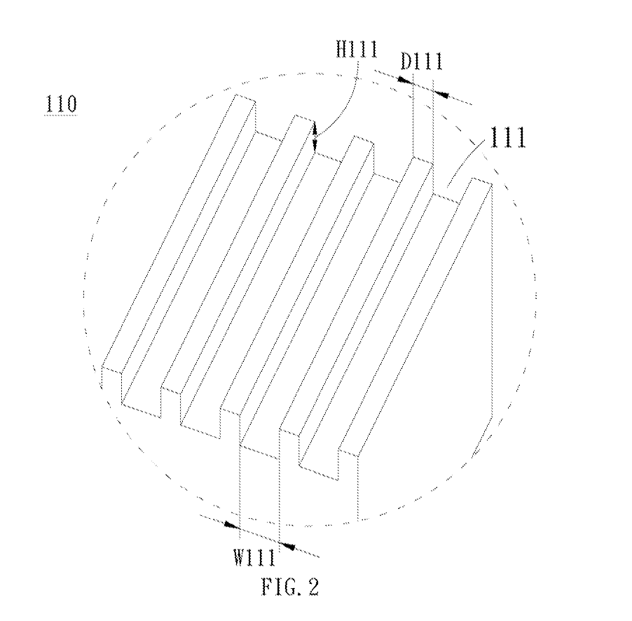

FIG. 2 shows a partial enlarged view of the schematic diagram of the engraving apparatus 10 of FIG. 1. In one embodiment, the plurality of micro-groove structures 111 are arranged in parallel. As embodiments, the distance D111 between every two of the adjacent micro-groove structures 111 is from 100 nanometers (nm) to 1,000 nm; the depth H111 of the micro-groove structures 111 is from 10 nm to 1,000 nm; and the width W111 of each of the micro-groove structures 111 is from 100 nm to 1,000 nm. In one embodiment, the engraving apparatus 10 rubs a roller surface of a roller using the engraving end 110 in a predetermined direction. Then, the predetermined pattern structures are rubbed on the roller surface of the roller. By changing rubbing direction, the engraving apparatus 10 makes different pattern structures In the rubbing process. Rotating the engraving apparatus 10 is not required to make different pattern structures.

In some embodiments, materials of the engraving end 110 are selected from materials featured with easily embossed to the roller and hardness greater than that of roller, such as diamond, metal or ceramic. In one preferred embodiment, the material of the engraving end 110 is made of diamond.

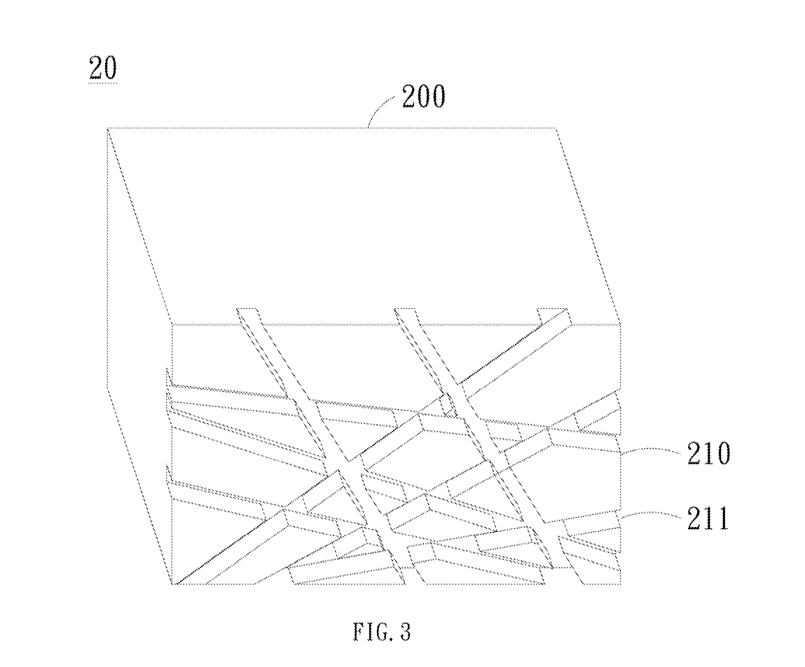

FIG. 3 shows the schematic diagram of another embodiment of an engraving apparatus 20 of the roller for manufacturing the retarder film (not shown) according to the present invention. The engraving apparatus 20 includes a body 200 and an engraving end 210. Wherein, the body 200 is hexahedral and the engraving end 210 is disposed at one side of the body 200. In addition, the engraving end 210 includes a plurality of micro-groove structures 211. The micro-groove structures 211 are irregular in pattern. In other words, the micro-groove structures 211 are arranged irregularly. The distance D211 between every two of the adjacent micro-groove structures 211 is from 0 nm to 1,000 nm. In addition, the depth and the width of each of the micro-groove structures 211 are the same to that of the micro-groove structures 111 respectively.

As embodiments, the engraving apparatus 10 includes the engraving end 110 all over with micro-groove structures 111. The micro-groove structures 111 are arranged in parallel (shown in FIG. 2) or in irregular pattern (shown in FIG. 3). In engraving process for a roller, the micro-groove structures 111 directly rubs the surface of the roller to directly generate the predetermined pattern structures thereon. When manufacturing a roller with a specific pattern structures on the roller surface, the engraving apparatus 10 rubs the roller surface backwards and forwards directly, without moving the engraving apparatus 10 to the starting position in engraving paths or changing the engraving direction of the engraving apparatus 10 to a specific direction each cycle. It speeds up the processing time to manufacturethe retarder film.

Furthermore, in that the manufactured micro-groove structures 111 have no specific direction but a structure with a direction controlled by the engraving process, the engraving apparatus according to the embodiments of the present invention can be flexibly applied to various designs of products, so as to keep the accuracy of manufactured retarder film as well.

According to the present invention, the engraving apparatus 10 rubs the predetermined structures with the micro-groove structures 111 on the engraving ends 110. The micro-groove structures 111 are not needed to be rotated back to a specific angle and the starting position so as to reduce the time required for the processing. In addition, damages to the micro-groove structures 111 is avoided because the micro-groove structures 111 directly rub the roller surface of the roller to form the predetermined pattern structures rather than from embossing the roller surface.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An engraving apparatus, comprising:
A body; and
an engraving end positioned in one side of the body,
wherein the engraving end has a plurality of micro-groove structures.

2. The engraving apparatus of claim 1, wherein the plurality of micro-groove structures are arranged in parallel.

3. The engraving apparatus of claim 2, wherein the distance between every two of the adjacent micro-groove structures is from 100 nm to 1,000 nm.

4. The engraving apparatus of claim 1, wherein the plurality of micro-groove structures are arranged irregularly.

5. The engraving apparatus of claim 4, wherein the distance between every two of the adjacent micro-groove structures is from 0 nm to 1,000 nm.

6. The engraving apparatus of claim 1, wherein the depth of each of the micro-groove structures is from 10 nm to 1,000 nm.

7. The engraving apparatus of claim 1, wherein the width of each of the micro-groove structures is from 100 nm to 1,000 nm.

8. The engraving apparatus of claim 1, wherein the engraving end is made of diamond.

9. The engraving apparatus of claim 1, wherein the engraving end is made of metal or ceramic.

10. The engraving apparatus of claim 1, wherein the engraving apparatus is used to rub rollers for manufacturing retarder films.
